(19) United States
(12) Patent Application Publication
(10) Pub. No.: US 2012/0206696 A1
(43) Pub. Date: Aug. 16, 2012

(54) PROJECTION DISPLAY APPARATUS AND IMAGE ADJUSTING METHOD

(75) Inventors: Masahiro HARAGUCHI, Daito-City (JP); Yoshinao HIRANUMA, Hirakata-City (JP); Masutaka INOUE, Hirakata-City (JP)

(73) Assignee: SANYO ELECTRIC CO., LTD, Moriguchi-shi (JP)

(21) Appl. No.: 13/398,284

(22) Filed: Feb. 16, 2012

(30) Foreign Application Priority Data
Feb. 16, 2011 (JP) 2011-031124

(51) Int. Cl. G03B 21/14

(52) U.S. Cl. 353/69

(57) ABSTRACT

A projection display apparatus displays a test pattern image including three or more intersections configured by three or more line segments. The projection display apparatus calculates a positional relationship between the projection display apparatus and the projection plane based on the three or more intersections included in the test pattern image. The test pattern image is included within a display frame.

### CROSS REFERENCE TO RELATED APPLICATIONS

This application claims priority of Japanese Patent Application No. 2011-031124 filed on Feb. 16, 2011. The contents of this application are incorporated herein by reference in their entirety.

### BACKGROUND OF THE INVENTION

1. Field of the Invention

The present invention relates to a projection display apparatus having an imager that modulates the light outputted from a light source, and a projection unit that projects the light outputted from the imager on a projection plane, and relates also to an image adjustment method therefor.

2. Description of the Related Art

Conventionally, there is known a projection display apparatus having an imager that modulates the light outputted from a light source, and a projection unit that projects the light outputted from the imager on a projection plane.

Here, depending on the positional relationship between the projection display apparatus and the projection plane, the shape of an image projected on the projection plane becomes distorted.

By contrast, a method of adjusting the shape of the image with the below procedure is proposed (for example, Japanese Unexamined Patent Application Publication No. 2005-318652). Firstly, the projection display apparatus projects a rectangular test pattern image on a projection plane. Secondly, the projection display apparatus captures the test pattern image projected on the projection plane, and specifies the coordinates at the four corners of the test pattern image on the projection plane. Thirdly, based on the coordinates at the four corners of the test pattern image on the projection plane, the projection display apparatus specifies the positional relationship between the projection display apparatus and the projection plane, and adjusts the shape of the image projected on the projection plane.

The imaging element that captures the test pattern image is that outputs the captured images in each predetermined line (for example, the row of pixels in the horizontal direction). In the aforementioned technology, the projection display apparatus acquires all the captured images from the imaging element, and then based on edge detection, directly specifies the coordinates at the four corners of the test pattern image.

Thus, according to the aforementioned technology, because the coordinates at the four corners of the test pattern image are specified directly, the processing load of specifying the coordinates at the four corners of the test pattern image is large. That is, in the aforementioned technology, the processing load of adjusting the shape of the image is large.

### SUMMARY OF THE INVENTION

A projection display apparatus according to a first feature includes an imager (liquid crystal panel 50) that modulates light outputted from a light source (light source 10), and a projection unit (projection unit 110) that projects the light outputted from the imager on a projection plane. The projection display apparatus includes: an element control unit (element control unit 250) that controls the imager so as to display a test pattern image including three or more intersections configured by three or more line segments; an acquisition unit (acquisition unit 230) that acquires a captured image of the test pattern image outputted along a predetermined line from an imaging element (imaging element 300) that captures the test pattern image projected on the projection plane, specifies the three or more line segments in the captured image of the test pattern image, and acquires the three or more intersections based on the three or more line segments in the captured image; a calculation unit (calculation unit 240) that calculates a positional relationship between the projection display apparatus and the projection plane based on the three or more intersections in the test pattern image and the three or more intersections in the captured image; and an adjustment unit (adjustment unit 270) that adjusts an image projected on the projection plane in accordance with the positional relationship between the projection display apparatus and the projection plane. The test pattern image projected on the projection plane is included within a display frame provided on the projection plane.

In the first feature, the three or more line segments included in the test pattern image have an inclination with respect to the predetermined line.

In the first feature, a maximum size of the test pattern image projected on the projection plane is determined based on a size of the display frame, an angle of view of the projection unit, a maximum inclining angle of the projection plane, and a maximum projection distance from the projection display apparatus to the projection plane.

In the first feature, a minimum size of the test pattern image projected on the projection plane is determined based on a resolution of the imaging element and a resolution of the imager.

In the first feature, the element control unit controls the imager so as to display a coordinate mapping image in which a plurality of characteristic points for mapping coordinates of the projection display apparatus and coordinates of the imaging element are arranged discretely. The element control unit controls the imager so as to display the coordinate mapping image, after estimating the mapping of a plurality of coordinates based on the captured image of the test pattern image.

An image adjustment method according to a second feature is a method of adjusting an image projected on a projection plane by a projection display apparatus. The image adjustment method includes: a step A of displaying a test pattern image including three or more intersections configured by three or more line segments; a step B of capturing the test pattern image projected on the projection plane, and acquiring a captured image of the test pattern image outputted along a predetermined line; and a step C of calculating a positional relationship between the projection display apparatus and the projection plane based on the captured image, and adjusting the image projected on the projection plane in accordance with the positional relationship between the projection display apparatus and the projection plane. In the step A, the test pattern image is displayed within a display frame provided on the projection plane.

In the second feature, the three or more line segments included in the test pattern image have an inclination with respect to the predetermined line.

### BRIEF DESCRIPTION OF THE DRAWINGS

FIG. 1 is a diagram showing an outline of a projection display apparatus 100 according to a first embodiment.

FIG. 2 is a diagram showing a configuration of the projection display apparatus 100 according to the first embodiment.

FIG. 3 is a block diagram showing a control unit 200 according to the first embodiment.

FIG. 4 is a diagram showing an example of a stored test pattern image according to the first embodiment.

FIG. 5 is a diagram showing an example of a captured test pattern image according to the first embodiment.

FIG. 6 is a diagram showing an example of a captured test pattern image according to the first embodiment.

FIG. 7 is a diagram for explaining the method of calculating the intersection in a projected test pattern image according to the first embodiment.

FIG. 8 is a diagram showing a display frame 420 according to the first embodiment.

FIG. 9 is a diagram for explaining the maximum size of a test pattern image according to the first embodiment.

FIG. 10 is a flowchart showing an operation of the projection display apparatus 100 according to the first embodiment.

FIG. 11 is a diagram for explaining a projectable range 410 and the size of the display frame 420 according to a first modification.

FIG. 12 is a diagram showing a test pattern image according to the first modification.

FIG. 13 is a diagram for explaining an estimation of the coordinates according to the first modification.

FIG. 14 is a diagram showing a coordinate mapping image according to the first modification.

### MODES FOR CARRYING OUT THE INVENTION

Hereinafter, a projection display apparatus according to embodiments of the present invention will be described with reference to the drawings. It is noted that in the following description of the drawings, identical or similar numerals are assigned to identical or similar parts.

It will be appreciated that the drawings are schematically shown and the ratio and the like of each dimension are different from the real ones. Accordingly, specific dimensions should be determined in consideration of the explanation below. Moreover, among the drawings, the respective dimensional relations or ratios may differ.

### OVERVIEW OF THE EMBODIMENT

A projection display apparatus according to the present embodiment includes an imager that modulates the light outputted from a light source, and a projection unit that project the light outputted from the imager on a projection plane. The projection display apparatus includes an element control unit that controls an imager so as to display a test pattern image including three or more intersections configured by three or more line segments, an acquisition unit that acquires a captured image of the test pattern image outputted along a predetermined line from an imaging element that captures the test pattern image projected on the projection plane, specifies the three or more line segments in the captured image of the test pattern image, and acquires the three or more intersections based on the three or more line segments in the captured image, a calculation unit that calculates a positional relationship between the projection display apparatus and the projection plane based on the three or more intersections in the test pattern image and the three or more intersections in the captured image, and an adjustment unit that adjusts the image projected on the projection plane in accordance with the positional relationship between the projection display apparatus and the projection plane. The test pattern image projected on the projection plane is included within a display frame provided on the projection plane.

Note that in order to include the test pattern image projected on the projection plane within the display frame, either (1) a size of the test pattern image may be predetermined so as to include the test pattern image within the display frame, or (2) a size of the test pattern image may be adjusted by the adjustment unit so as to include the test pattern image within the display frame.

In the present embodiment, the test pattern image projected on the projection plane is included within a display frame provided on the projection plane. That is, the three or more intersections included in the test pattern image are included within a display frame. Therefore, it is possible to improve the calculation accuracy of the positional relationship between the projection display apparatus and the projection plane.

Moreover, the three or more line segments included in the test pattern image have an inclination with respect to the predetermined line. Firstly, as compared to the case when the line segments included in the test pattern image are along a predetermined line, the number of columns of the line memory can be reduced when edge detection is performed. Therefore, the processing load of adjusting the image can be reduced. Secondly, as compared to the case when the line segments included in the test pattern image are along a predetermined line, the detection accuracy of the line segments included in the test pattern image improves.

### First Embodiment

### Outline of Projection Display Apparatus

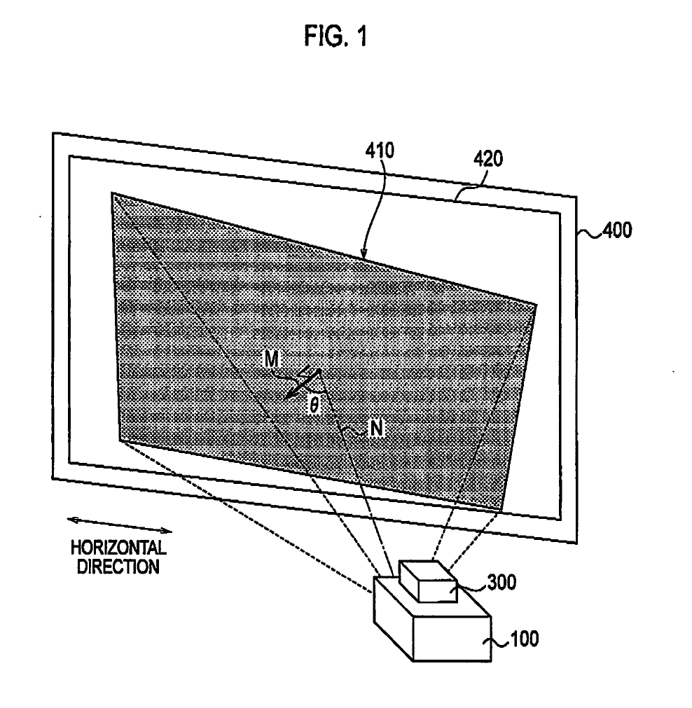

Hereinafter, a projection display apparatus according to a first embodiment is explained with reference to drawings. FIG. 1 is a diagram showing an outline of a projection display apparatus 100 according to the first embodiment.

As shown in FIG. 1, an imaging element 300 is provided in the projection display apparatus 100. Furthermore, the projection display apparatus 100 projects the image light on the projection plane 400.

The imaging element 300 captures the projection plane 400. That is, the imaging element 300 detects the reflected light of the image light projected on the projection plane 400 by the projection display apparatus 100. The imaging element 300 outputs the captured image along a predetermined line with respect to the projection display apparatus 100. The imaging element 300 may be built inside the projection display apparatus 100, or may be set up as an annex to the projection display apparatus 100.

The projection plane 400 is configured by a screen, or the like. The range in which the projection display apparatus 100 can project the image light (projectable range 410) is formed on the projection plane 400. Furthermore, the projection plane 400 has a display frame 420 configured by an outer frame of the screen.

The first embodiment illustrates a case in which the optical axis N of the projection display apparatus 100 does not match the normal line M of the projection plane 400. For example, the first embodiment illustrates a case in which the optical axis N and the normal line M configure an angle θ.

That is, according to the first embodiment, because the optical axis N and the normal line M do not match, the projectable range 410 (image displayed on the projection plane 400) becomes distorted. The first embodiment mainly explains a method of correcting such a distortion of the projectable range 410.

### (Configuration of the Projection Display Apparatus)

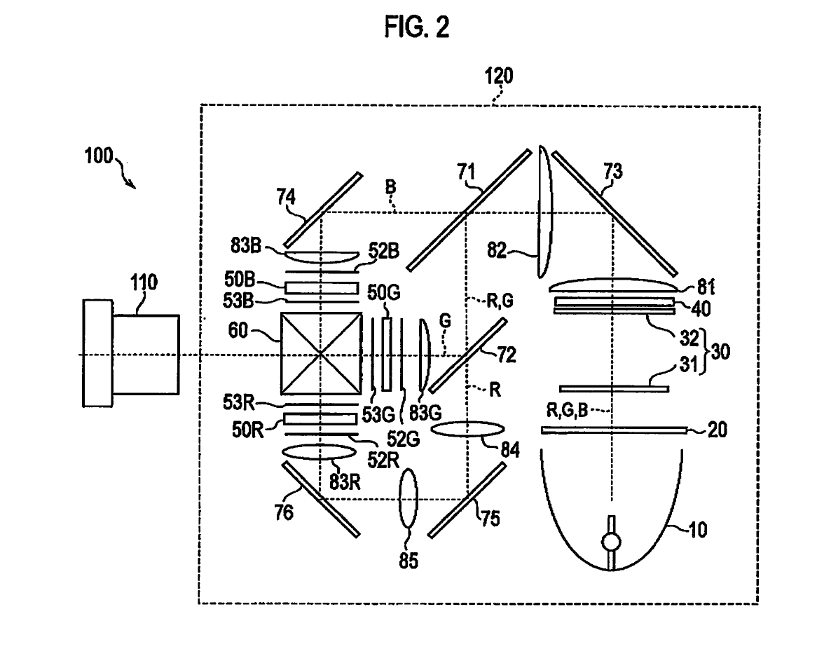

Hereinafter, a projection display apparatus according to a first embodiment is explained with reference to drawings. FIG. 2 is a diagram showing a configuration of the projection display apparatus 100 according to the first embodiment.

As shown in FIG. 2, the projection display apparatus 100 has a projection unit 110 and an illumination device 120.

The projection unit 110 projects the image light outputted from the illumination device 120 on a projection plane (not shown in the figure), for example.

Firstly, the illumination device 120 has a light source 10, a UV/IR cut filter 20, a fly-eye lens unit 30, a PBS array 40, a plurality of liquid crystal panels 50 (a liquid crystal panel 50R, a liquid crystal panel 50G, and a liquid crystal panel 50B), and a cross-dichroic prism 60.

The light source 10 is a light source emitting white light (such as a UHP lamp and a xenon lamp). That is, the white light outputted from the light source 10 includes red-component light R, green-component light G, and blue-component light B.

The UV/IR cut filter 20 allows the visible light components (red-component light R, green-component light G, and blue-component light B) to pass through. The UV/IR cut filter 20 blocks the infrared light component and the ultraviolet light component.

The fly-eye lens unit 30 equalizes the light outputted from the light source 10. Specifically, the fly-eye lens unit 30 is configured by a fly-eye lens 31 and a fly-eye lens 32. Each of the fly-eye lens 31 and the fly-eye lens 32 is configured by a plurality of minute lenses. Each minute lens concentrates the light outputted from the light source 10 such that the light outputted from the light source 10 is irradiated on the entire surface of the liquid crystal panel 50.

The PBS array 40 arranges the polarization state of the light outputted from the fly-eye lens unit 80. For example, the PBS array 40 arranges the light outputted from the fly-eye lens unit 30 in S polarization (or P polarization).

The liquid crystal panel 50R modulates the red-component light R based on the red output signal Rₒᵤₜ. On the side from where the light enters the liquid crystal panel 50R, an incident-side polarization plate 52R is provided that allows the light having one polarization direction (for example, S polarization) to pass through, and blocks the light having the other polarization direction (for example, P polarization). On the side from where the light outputted from the liquid crystal panel 50R, an output-side polarization plate 53R is provided that blocks the light having one polarization direction (for example, S polarization), and allows the light having the other polarization direction (for example, P polarization) to pass through.

The liquid crystal panel 50G modulates the green-component light G based on the green output signal Gₒᵤₜ. On the side from where the light enters the liquid crystal panel 50G, an incident-side polarization plate 52G is provided that allows the light having one polarization direction (for example, S polarization) to pass through, and blocks the light having the other polarization direction (for example, P polarization). On the other hand, on the side from where the light outputted from the liquid crystal panel 50G, an output-side polarization plate 53G is provided that blocks the light having one polarization direction (for example, S polarization), and allows the light having the other polarization direction (for example, P polarization) to pass through.

The liquid crystal panel 50B modulates the blue-component light B based on the blue output signal Bₒᵤₜ. On the side from where the light enters the liquid crystal panel 50B, an incident-side polarization plate 52B is provided that allows the light having one polarization direction (for example, S polarization) to pass through, and blocks the light having the other polarization direction (for example, P polarization). On the other hand, on the side from where the light outputted from the liquid crystal panel 50B, an output-side polarization plate 53B is provided that blocks the light having one polarization direction (for example, S polarization), and allows the light having the other polarization direction (for example, P polarization) to pass through.

Note that the red output signal Rₒᵤₜ, the green output signal Gₒᵤₜ, and the blue output signal Bₒᵤₜ configure the image output signal. The image output signal is a signal for each of a plurality of pixels that configure a single frame.

Here, a compensating plate (not shown in the figure) that improves the contrast ratio and the transmittance may be provided in each liquid crystal panel 50. Furthermore, each polarization plate can also have a pre-polarization plate that reduces the amount of light entering the polarization plate and the thermal burden.

The cross-dichroic prism 60 configures a color combining unit that combines the light outputted from the liquid crystal panel 50R, the liquid crystal panel 50G, and the liquid crystal panel 50B. The combined light outputted from the cross-dichroic prism 60 is guided to the projection unit 110.

Secondly, the illumination device 120 has a mirror group (a mirror 71 to a mirror 76) and a lens group (a lens 81 to a lens 85).

The mirror 71 is a dichroic mirror that allows the blue-component light B to pass through and reflects the red-component light R and the green-component light G. The mirror 72 is a dichroic mirror that allows the red-component light R to pass through and reflects the green-component light G. The mirror 71 and the mirror 72 configure a color separation unit that separates the red-component light R, the green-component light G, and the blue-component light B.

The mirror 73 reflects the red-component light R, the green-component light G, and the blue-component light B, and guides the red-component light R, the green-component light G, and the blue-component light B to the mirror 71 side. The mirror 74 reflects the blue-component light B, and guides the blue-component light B to the liquid crystal panel 50B side. The mirror 75 and the mirror 76 reflect the red-component light R, and guide the red-component light R to the liquid crystal panel 50R side.

The lens 81 is a condenser lens that concentrates the light outputted from the PBS array 40. The lens 82 is a condenser lens that concentrates the light reflected by the mirror 73.

The lens 83R generally collimates the red-component light R such that the red-component light R is irradiated on the liquid crystal panel 50R. The lens 83G generally collimates the green-component light G such that the green-component light G is irradiated on the liquid crystal panel 50G. The lens 83B generally collimates the blue-component light B such that the blue-component light B is irradiated on the liquid crystal panel 50B.

The lens 84 and the lens 85 are relay lenses that form a general image of the red-component light R on the liquid crystal panel 50R while suppressing the amplification of the red-component light R.

### (Configuration of the Control Unit)

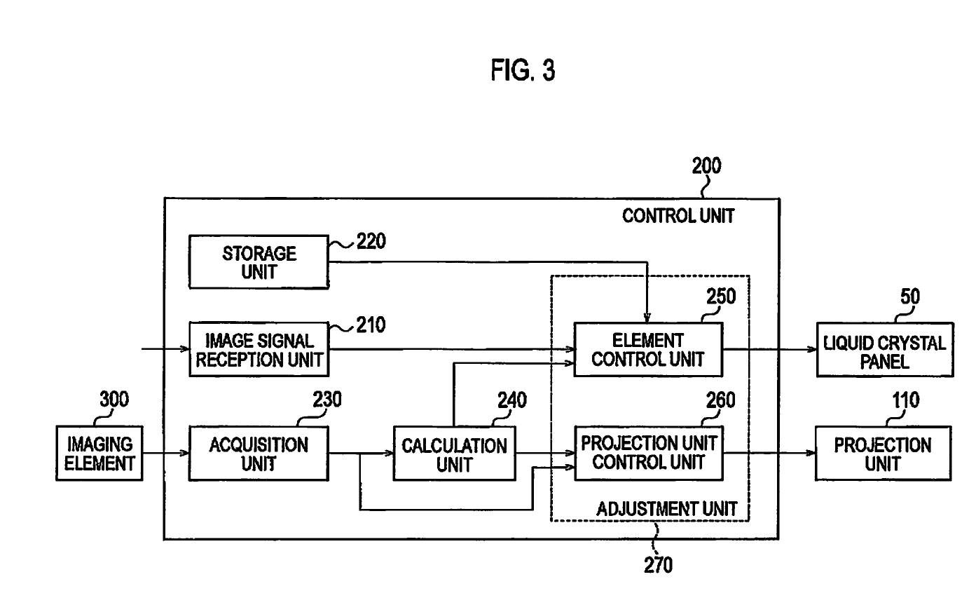

Hereinafter, the control unit according to the first embodiment is explained with reference to drawings. FIG. 3 is a block diagram showing a control unit 200 according to the first embodiment. The control unit 200 is provided in the projection display apparatus 100 and controls the projection display apparatus 100.

Note that the control unit 200 converts an image input signal to an image output signal. The image input signal is configured by a red input signal Rᵢₙ, a green input signal Gᵢₙ, and a blue input signal Bᵢₙ. The image output signal is configured by the red output signal Rₒᵤₜ, the green output signal Gₒᵤₜ, and the blue output signal Bₒᵤₜ. The image input signal and the image output signal are signals that are input for each of a plurality of pixels that configure a single frame.

As shown in FIG. 3, the control unit 200 has an image signal reception unit 210, a storage unit 220, an acquisition unit 230, a calculation unit 240, an element control unit 250, and a projection unit adjustment unit 260.

The image signal reception unit 210 receives an image input signal from an external device (not shown in the figure) such as a DVD and a TV tuner.

The storage unit 220 stores various types of information. Specifically, the storage unit 220 stores a frame detection pattern image used for detecting the display frame 420, a focus adjustment image used for adjusting the focus, and a test pattern image used for calculating the positional relationship between the projection display apparatus 100 and the projection plane 400. Alternately, the storage unit 220 may store an exposure adjustment image used for adjusting the exposure value.

The test pattern image is an image having three or more intersections configured by three or more line segments. Furthermore, the three or more line segments have an inclination with respect to a predetermined line.

Note that as described above, the imaging element 300 outputs the captured image along a predetermined line. For example, the predetermined line is a pixel array in the horizontal direction, and the orientation of the predetermined line is in the horizontal direction.

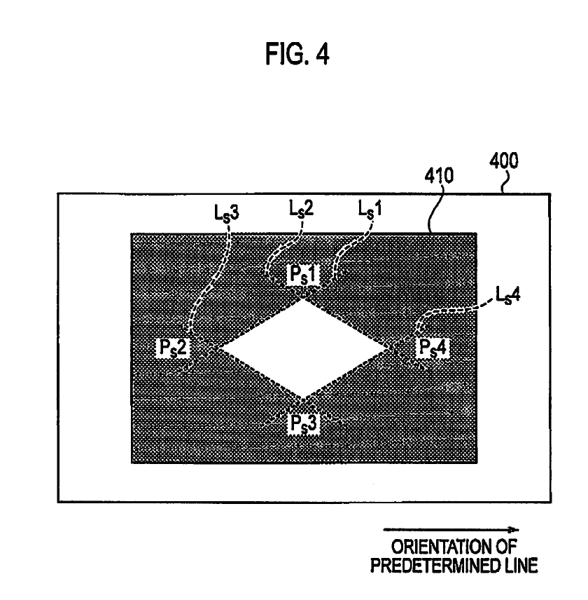

Hereinafter, an example of a test pattern image is explained with reference to FIG. 4. As shown in FIG. 4, the test pattern image is an image including four intersections (Pₛ1 through Pₛ4) configured by four line segments (Lₛ1 through Lₛ4). In the first embodiment, the four line segments (Lₛ1 through Lₛ4) are expressed in terms of difference (edge) in intensity or contrast.

In detail, as shown in FIG. 4, the test pattern image may be a black background and a void rhombus. Here, the four edges of the void rhombus configure at least a part of the four line segments (Lₛ1 through Lₛ4). Note that the four line segments (Lₛ1 through Lₛ4) have an inclination with respect to a predetermined line (horizontal direction).

Firstly, the acquisition unit 230 acquires a captured image outputted along a predetermined line from the imaging element 300. For example, the acquisition unit 230 acquires a captured image of the frame detection pattern image outputted along a predetermined line from the imaging element 300. The acquisition unit 230 acquires a captured image of the focus adjustment image outputted along a predetermined line from the imaging element 300. The acquisition unit 230 acquires a captured image of the test pattern image outputted along a predetermined line from the imaging element 300. Alternately, the acquisition unit 230 may acquire a captured image of the exposure adjustment image outputted along a predetermined line from the imaging element 300.

Secondly, based on the captured image acquired for each predetermined line, the acquisition unit 230 acquires the three line segments included in the captured image. Following this, based on the three line segments included in the captured image, the acquisition unit 230 acquires the three or more intersections included in the captured image.

Specifically, with the below procedure, the acquisition unit 230 acquires the three or more intersections included in the captured image. Here, a case where the test pattern image is an image (void rhombus) shown in FIG. 4 is illustrated.

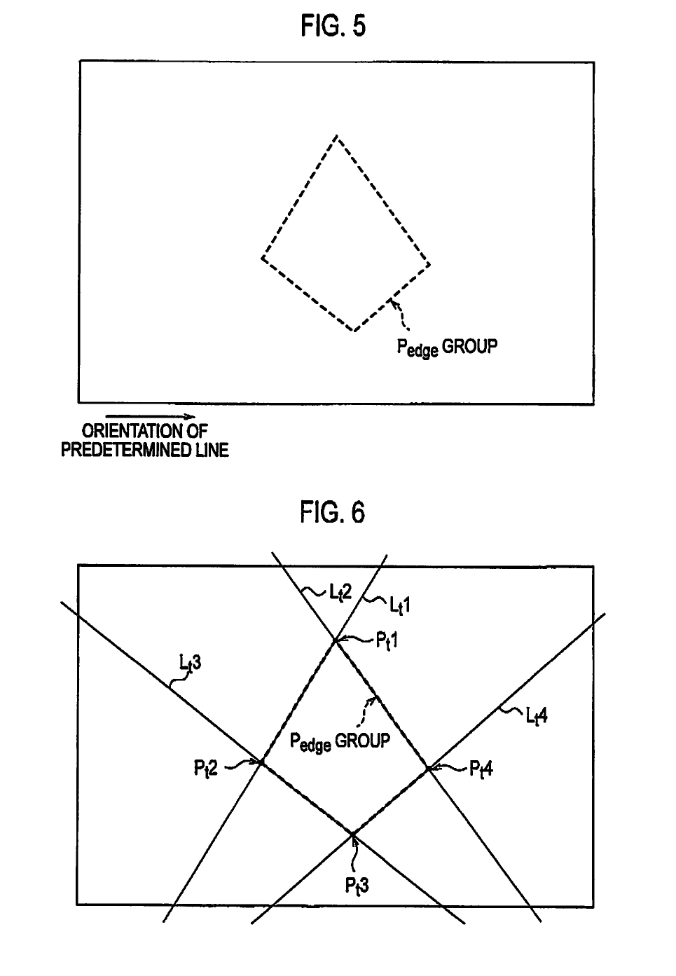

(1) As shown in FIG. 5, based on the captured image acquired for each predetermined line, the acquisition unit 230 acquires a point group P_{edge} having a difference (edge) in intensity or contrast. That is, the acquisition unit 230 specifies the point group P_{edge} corresponding to the four edges of the void rhombus of the test pattern image.

(2) As shown in FIG. 6, based on the point group P_{edge}, the acquisition unit 230 specifies the four line segments (Lₜ1 through Lₜ4) included in the captured image. That is, the acquisition unit 230 specifies the four line segments (Lₜ1 through Lₜ4) corresponding to the four line segments (Lₛ1 through Lₛ4) included in the test pattern image.

(3) As shown in FIG. 6, based on the four line segments (Lₜ1 through Lₜ4), the acquisition unit 230 specifies the four intersections (Pₜ1 through Pₜ4) included in the captured image. That is, the acquisition unit 230 specifies the four intersections (Pₜ1 through Pₜ4) corresponding to the four intersections (Pₛ1 through Pₛ4) included in the test pattern image.

Based on the three or more intersections (for example, Pₛ1 through Pₛ4) included in the test pattern image and three intersections (for example, Pₜ1 through Pₜ4) included in the captured image, the calculation unit 240 calculates the positional relationship between the projection display apparatus 100 and the projection plane 400. Specifically, the calculation unit 240 calculates the amount of deviation between the optical axis N of the projection display apparatus 100 (projection unit 110) and the normal line M of the projection plane 400.

Note that hereinafter, the test pattern image stored in the storage unit 220 is called the stored test pattern image. The test pattern image included in the captured image is called the captured test pattern image. The test pattern image projected on the projection plane 400 is called the projected test pattern image.

Firstly, the calculation unit 240 calculates the coordinates of the four intersections (Pᵤ1 through Pᵤ4) included in the projected test pattern image. Here, the intersection Pₛ1 of the stored test pattern image, the intersection Pₜ1 of the captured test pattern image, and the intersection Pᵤ1 of the projected test pattern image are explained as examples. The intersection Pₛ1, the intersection Pₜ1, and the intersection Pᵤ1 are mutually corresponding to each other.

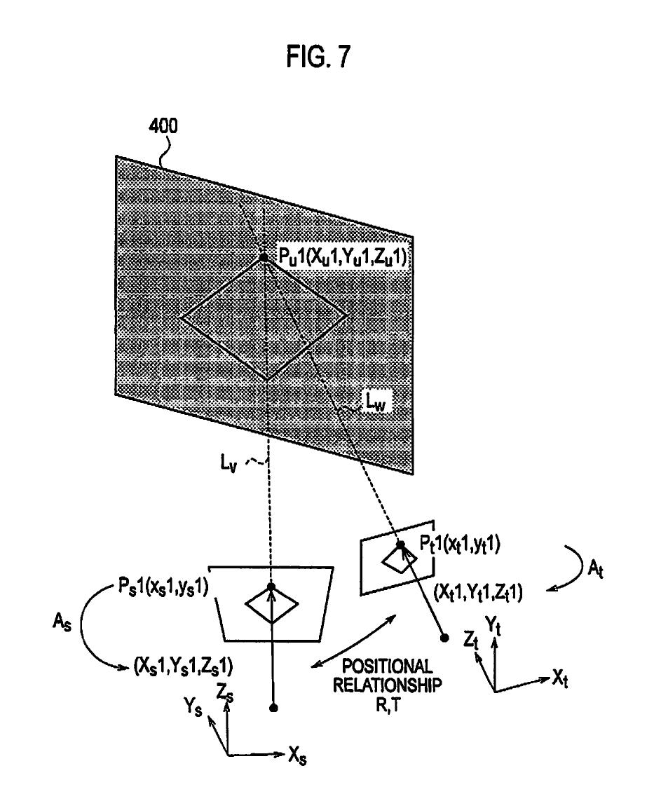

Hereinafter, the method of calculating the coordinates (Xᵤ1, Yᵤ1, Zᵤ1) of the intersection Pᵤ1 is explained with reference to FIG. 7. It should be noted that the coordinates (Xᵤ1, Yᵤ1, Zᵤ1) of the intersection Pᵤ1 are the coordinates in a three dimensional space where the focal point Oₛ of the projection display apparatus 100 is the origin.

(1) The calculation unit 240 transforms the coordinates (xₛ1, yₛ4) of the intersection Pₛ1 in a two-dimensional plane of the stored test pattern image to the coordinates (Xₛ1, Yₛ1, Zₛ1) of the intersection Pₛ1 in a three-dimensional space where the focal point Oₛ of the projection display apparatus 100 is the origin. Specifically, the coordinates (Xₛ1, Yₛ1, Zₛ1) of the intersection Pₛ1 are expressed by the following equation:

$$( \begin{matrix}{X}_{s} 1 \\ {Y}_{s} 1 \\ {Z}_{s} 1\end{matrix} ) = As ( \begin{matrix}{x}_{s} 1 \\ {y}_{s} 1 \\ 1\end{matrix} ) \qquad EQUATION ( 1 )$$

Note that As is a 3×3 transformation matrix, which can be acquired beforehand by pre-processing such as calibration. That is, As is a known parameter.

Here, the vertical plane in the direction of the optical axis of the projection display apparatus 100 is expressed by the Xₛ axis and Yₛ axis, and the direction of the optical axis of the projection display apparatus 100 is expressed by the Zₛ axis.

Similarly, the calculation unit 240 transforms the coordinates (xₜ1, yₜ1) of the intersection Pₜ1 in a two-dimensional plane of the captured test pattern image to the coordinates (Xₜ1, Yₜ1, Zₜ1) of the intersection Pₜ1 in a three-dimensional space where the focal point Oₜ of the imaging element 300 is the origin.

$$( \begin{matrix}{X}_{t} 1 \\ {Y}_{t} 1 \\ {Z}_{t} 1\end{matrix} ) = At ( \begin{matrix}{x}_{t} 1 \\ {y}_{t} 1 \\ 1\end{matrix} ) \qquad EQUATION ( 2 )$$

Note that At is a 3×3 transformation matrix, which can be acquired beforehand by pre-processing such as calibration. That is, At is a known parameter.

Here, the vertical plane in the direction of the optical axis of the imaging element 300 is expressed by the Xₜ axis and Yₜ axis, and the orientation of the imaging element 300 (imaging direction) is expressed by the Zₜ axis. It should be noted that in such a coordinate space, the inclination (vector) of the orientation of the imaging element 300 (imaging direction) is already known.

(2) The calculation unit 240 calculates the equation of the straight line Lᵥ that joins the intersection Pₛ1 and the intersection Pᵤ1. Similarly, the calculation unit 240 calculates the equation of the straight line L_{w} that joins the intersection Pₜ1 and the intersection Pᵤ1. Note that the equation of the straight line Lᵥ and the straight line L_{w} is expressed as shown below:

$$\begin{matrix}{L}_{v} = ( \begin{matrix}{x}_{s} \\ {y}_{s} \\ {z}_{s}\end{matrix} ) = {K}_{s} ( \begin{matrix}{X}_{s} 1 \\ {Y}_{s} 1 \\ {Z}_{s} 1\end{matrix} ) & EQUATION ( 3 ) \\ {L}_{w} = ( \begin{matrix}{x}_{t} \\ {y}_{t} \\ {z}_{t}\end{matrix} ) = {K}_{t} ( \begin{matrix}{X}_{t} 1 \\ {Y}_{t} 1 \\ {Z}_{t} 1\end{matrix} ) & EQUATION ( 4 )\end{matrix}$$

In this case, Kₛ and Kₜ=parameter

(3) The calculation unit 240 transforms the straight line L_{w} to the straight line L_{w}′ in a three-dimensional space where the focal point Oₛ of the projection display apparatus 100 is the origin. The straight line L_{w}′ is expressed by the following equation:

$${L}_{w}^{′} = ( \begin{matrix}{x}_{t}^{′} \\ {y}_{t}^{′} \\ {z}_{t}^{′}\end{matrix} ) = {K}_{t} R ( \begin{matrix}{X}_{t} 1 \\ {Y}_{t} 1 \\ {Z}_{t} 1\end{matrix} ) + T \qquad EQUATION ( 5 )$$

Note that because the optical axis of the projection display apparatus 100 and the orientation of the imaging element 300 (imaging direction) is already known, the parameter R showing the rotational component is already known. Similarly, because the relative position of the projection display apparatus 100 and the imaging element 300 is already known, the parameter T showing the translation component is already known.

(4) The calculation unit 240 calculates the parameters Kₛ and Kₜ in the intersection of the straight line Lᵥ and the straight line L_{w}′ (that is, the intersection Pᵤ1) based on the equation (3) and equation (5). Following this, the calculation unit 240 calculates the coordinates (Xᵤ1, Yᵤ1, Zᵤ1) of the intersection Pᵤ1 based on the coordinates (Xₛ1, Yₛ1, Zₛ1) of the intersection Pₛ1 and Kₛ. Alternately, the calculation unit 240 calculates the coordinates (Xᵤ1, Yᵤ1, Zᵤ1) of the intersection Pᵤ1 based on the coordinates (Xₜ1, Yₜ1, Zₜ1) of the intersection Pₜ1 and Kₜ.

Thus, the calculation unit 240 calculates the coordinates (Xᵤ1, Yᵤ1, Zᵤ1) of the intersection Pᵤ1. Similarly, the calculation unit 240 calculates the coordinates (Xᵤ2, Yᵤ2, Zᵤ2) of the intersection Pᵤ2, the coordinates (Xᵤ3, Yᵤ3, Zᵤ3) of the intersection Pᵤ3, and the coordinates (Xᵤ4, Yᵤ4, Zᵤ4) of the intersection Pᵤ4.

Secondly, the calculation unit 240 calculates the vector of the normal line M of the projection plane 400. Specifically, of the intersections Pᵤ1 through Pᵤ4, the calculation unit 240 uses the coordinates of at least three intersections to calculate the vector of the normal line M of the projection plane 400. The equation of the projection plane 400 is expressed as shown below, and the parameters k₁, k₂, and k₃ express the vector of the normal line M of the projection plane 400.

k₁x+k₂y+k₃z+k₄=0 EQUATION (6)

In this case, k₃, k₂, k₁, k₄=predetermined coefficient

Thus, the calculation unit 240 can calculate the amount of deviation between the optical axis N of the projection display apparatus 100 and the normal line M of the projection plane 400. That is, the calculation unit 240 can calculate the positional relationship between the projection display apparatus 100 and the projection plane 400.

Returning to FIG. 3, the element control unit 250 converts the image input signal to the image output signal, and then controls the liquid crystal panel 50 based on the image output signal. Furthermore, the element control unit 250 has the below function.

Specifically, the element control unit 250 has a function of automatically correcting the shape of the image (shape adjustment) projected on the projection plane 400 based on the positional relationship between the projection display apparatus 100 and the projection plane 400. That is, the element control unit 250 has the function of automatically performing keystone correction based on the positional relationship of the projection display apparatus 100 and the projection plane 400.

The projection unit adjustment unit 260 controls the lens group provided in the projection unit 110.

Firstly, as a result of shifting of the lens group provided in the projection unit 110, the projection unit adjustment unit 260 includes the projectable range 410 within the display frame 420 provided on the projection plane 400 (zoom adjustment). Specifically, based on the captured image of the frame detection pattern image acquired by the acquisition unit 230, the projection unit adjustment unit 260 controls the lens group provided in the projection unit 110 such that the projectable range 410 is included within the display frame 420.

Secondly, as a result of shifting of the lens group provided in the projection unit 110, the projection unit adjustment unit 260 adjusts the focus of the image projected on the projection plane 400 (focus adjustment). Specifically, based on the captured image of the focus adjustment image acquired by the acquisition unit 230, the projection unit adjustment unit 260 controls the lens group provided in the projection unit 110 such that the focus value of the image projected on the projection plane 400 becomes maximum.

Note that the element control unit 250 and the projection unit adjustment unit 260 configure the adjustment unit 270 that adjusts the image projected on the projection plane 400.

According to the first embodiment, the test pattern image projected on the projection plane 400 (projected test pattern image) is included within the display frame 420.

In order to include the projected test pattern image within the display frame 420, either (1) the size of the stored test pattern image may be predetermined so as to include the projected test pattern image within the display frame 420, or (2) the size of the projected test pattern image may be adjusted by the adjustment unit 270 so as to include the projected test pattern image within the display frame 420. That is, the projected test pattern image may be included within the display frame 420 by signal processing of the element control unit 250, or the projected test pattern image may be included within the display frame 420 by focus adjustment of the projection unit adjustment unit 260.

### (Maximum Size of the Test Pattern Image)

Hereinafter, the maximum size of the test pattern image is explained. The maximum size of the test pattern image is determined based on the size of the display frame 420, the angle of view of the projection unit 110, the maximum inclining angle of the projection plane 400, and the maximum projection distance from the projection display apparatus 100 to the projection plane 400.

Here, the size of the display frame 420 can be acquired by frame detection using the frame detection pattern image. The angle of view of the projection unit 110 is predetermined as a rating of the projection display apparatus 100. The maximum inclining angle of the projection plane 400 is the maximum inclining angle of the projection plane 400 with respect to the vertical plane in the projection direction, and is predetermined as a rating of the projection display apparatus 100. The maximum projection distance is predetermined as a rating of the projection display apparatus 100.

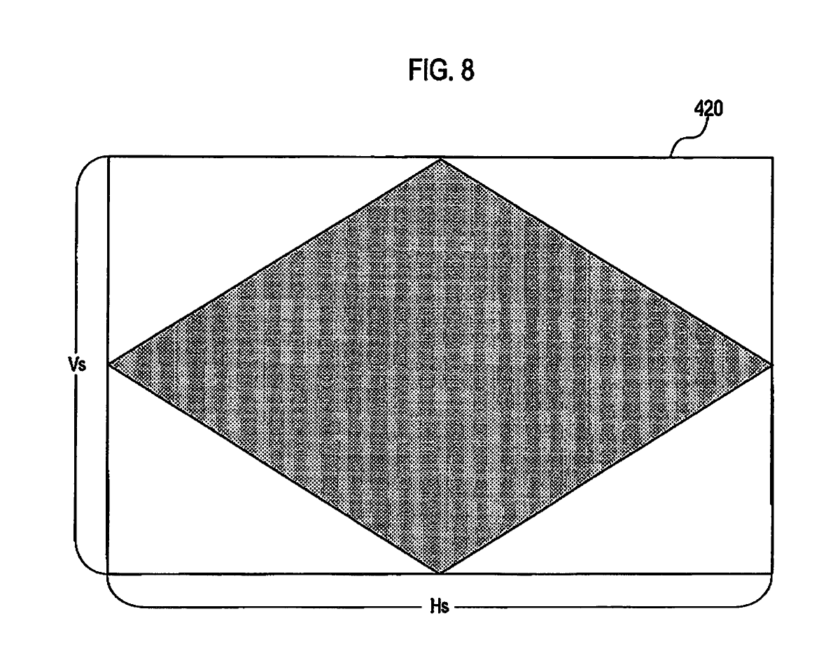

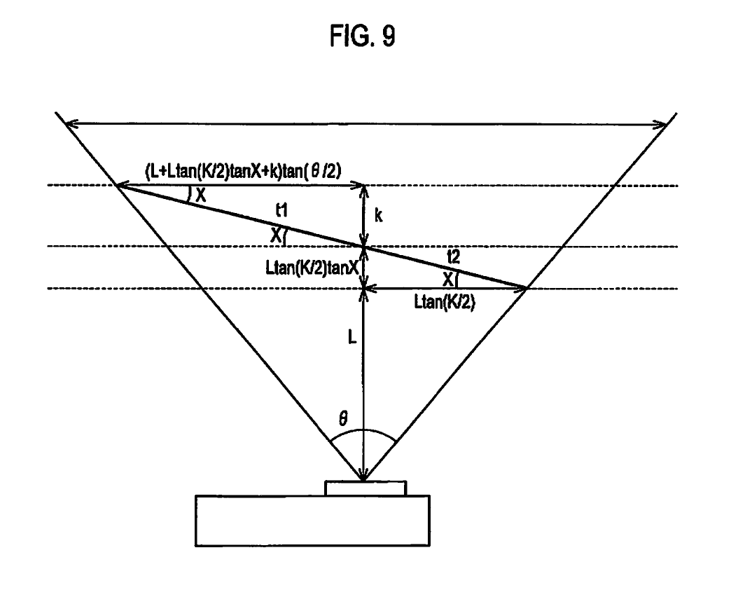

Here, the maximum size of the test pattern image in the horizontal direction is explained with reference to FIG. 8 and FIG. 9.

For example, as shown in FIG. 8, the size of the display frame 420 in the horizontal direction is expressed by Hs. Furthermore, as shown in FIG. 9, the angle of view of the projection unit 110 is expressed by θ, the maximum inclining angle of the projection plane 400 is expressed by X, and the maximum projection distance is expressed by L.

In such a case, the size of the test pattern image in the horizontal direction is expressed by t1+t2. Here, the size “t1+t2” of the test pattern image in the horizontal direction must satisfy t1+t2<Hs.

Note that t1 and t2 are expressed by the following equations:

$$\begin{matrix}t 1 = \frac{k}{( cos ( 90 - X ) )} & EQUATION ( 7 ) \\ t 2 = \frac{L tan \frac{θ}{2}}{cos X} & EQUATION ( 8 )\end{matrix}$$

Note that the value k satisfies the following equation:

$$k = ( L + L tan ( \frac{K}{2} ) tan X + k ) tan ( \frac{θ}{2} ) \times tan X \qquad EQUATION ( 9 )$$

When the equation (9) is solved for the value k, the value k is expressed by the following equation:

$$k = \frac{( L + L tan ( \frac{K}{2} ) tan X ) \times tan X}{( 1 - \{ tan ( \frac{θ}{2} ) \times tan X \} )} \qquad EQUATION ( 10 )$$

Therefore, as for the maximum size of the test pattern image in the horizontal direction, “t1+t2” is the maximum value as long as “t1+t2”<Hs is satisfied.

Needless to say, the same method as that for the maximum size of the test pattern image in the horizontal direction can be used for the maximum size of the test pattern image in the vertical direction as well.

### (Minimum Size of the Test Pattern Image)

Hereinafter, the minimum size of the test pattern image is explained. The minimum size of the test pattern image is determined based on the resolution of the imaging element 300 and the resolution of the liquid crystal panel 50.

Here, if the imaging element 300 is provided in the projection display apparatus 100, the relationship between the angle of view of the projection display apparatus 100 and the angle of view of the imaging element 300 does not change even when the distance between the projection display apparatus 100 and the projection plane 400 changes.

Furthermore, in order to specify one edge of the test pattern image, two pixels may be detected by the imaging element 300 in one edge of the test pattern image.

Therefore, when the resolution of the liquid crystal panel 50 is Rp and the resolution of the imaging element 300 is Rc, it is desirable that the number of pixels “k” of one edge of the test pattern image satisfy the relationship k≧2Rp/Rc.

### (Operation of the Projection Display Apparatus)

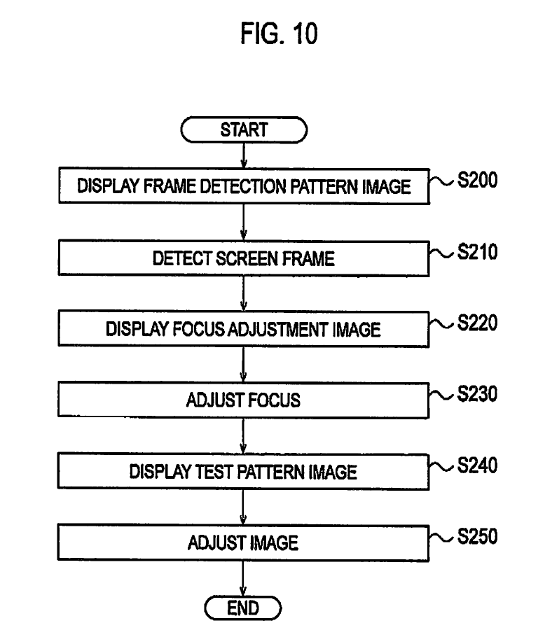

Hereinafter, the operation of the projection display apparatus (control unit) according to the first embodiment is explained with reference to drawings. FIG. 10 is a flowchart showing an operation of the projection display apparatus 100 (control unit 200) according to the first embodiment.

As shown in FIG. 10, in step 200, the projection display apparatus 100 displays (projects) the frame detection pattern image on the projection plane 400. The frame detection pattern image is a white image, for example.

In step 210, the imaging element 300 provided in the projection display apparatus 100 captures the projection plane 400. That is, the imaging element 300 captures the frame detection pattern image projected on the projection plane 400. Following this, the projection display apparatus 100 detects the display frame 420 provided on the projection plane 400 based on the captured image of the frame detection pattern image.

In step 220, the projection display apparatus 100 displays (projects) the focus adjustment image on the projection plane 400.

In step 230, the imaging element 300 provided in the projection display apparatus 100 captures the projection plane 400. That is, the imaging element 300 captures the focus adjustment image projected on the projection plane 400. Following this, the projection display apparatus 100 adjusts the focus of the focus adjustment image such that the focus value of the focus adjustment image becomes maximum value.

In step 240, the projection display apparatus 100 displays (projects) the test pattern image on the projection plane 400.

It should be noted that according to the first embodiment, the test pattern image projected on the projection plane 400 (projected test pattern image) is included within the display frame 420.

In step 250, the imaging element 300 provided in the projection display apparatus 100 captures the projection plane 400. That is, the imaging element 300 captures the test pattern image projected on the projection plane 400. Following this, the projection display apparatus 100 specifies the four line segments (Lₜ1 through Lₜ4) included in the captured test pattern image, and then specifies the four intersections (Pₜ1 through Pₜ4) included in the captured test pattern image based on the four line segments (Lₜ1 through Lₜ4). The projection display apparatus 100 calculates the positional relationship between the projection display apparatus 100 and the projection plane 400 based on the four intersections (Pₛ1 through Pₛ4) included in the stored test pattern image and the four intersections (Pₜ1 through Pₜ4) included in the captured test pattern image. Based on the positional relationship between the projection display apparatus 100 and the projection plane 400, the projection display apparatus 100 adjusts the shape of the image projected on the projection plane 400 (keystone correction).

### (Operation and Effect)

According to the first embodiment, the three or more line segments included in the test pattern image have an inclination with respect to a predetermined line. Firstly, as compared to the case when the line segments included in the test pattern image are along a predetermined line, the number of columns of the line memory can be reduced when edge detection is performed. Therefore, the processing load of adjusting the image can be reduced. Secondly, as compared to the case when the line segments included in the test pattern image are along a predetermined line, the detection accuracy of the line segments included in the test pattern image improves.

According to the first embodiment, the test pattern image projected on the projection plane 400 is included within the display frame 420 provided in the projection plane 400. That is, the three or more intersections included in the test pattern image are included within the display frame 420. Therefore, the calculation accuracy of the positional relationship between the projection display apparatus 100 and the projection plane 400 improves.

### [First Modification]

Hereafter, a first modification of the first embodiment is explained. The explanation below is based primarily on the differences with respect to the first embodiment.

Specifically, according to the first modification, the element control unit 250 controls the liquid crystal panel 50 so as to display a coordinate mapping image in which a plurality of characteristic points for mapping the coordinates of the projection display apparatus 100 and the coordinates of the imaging element 300 are arranged discretely.

For example, it should be noted that in order to provide an interactive function, the coordinates of the projection display apparatus 100 and the coordinates of the imaging element 300 must be mapped. Furthermore, it should be noted that in cases where the projection plane 400 is a curved surface, a plurality of characteristic points must be arranged discretely in the coordinate mapping image.

Note that the plurality of characteristic points may be arranged discretely in the region necessary for the interactive function (for example, the right end of the projectable range 410). Alternately, the plurality of characteristic points may be arranged discretely in the entire projectable range 410.

In detail, the mapping between the coordinates of the projection display apparatus 100 and the coordinates of the imaging element 300 is performed according to the below procedure.

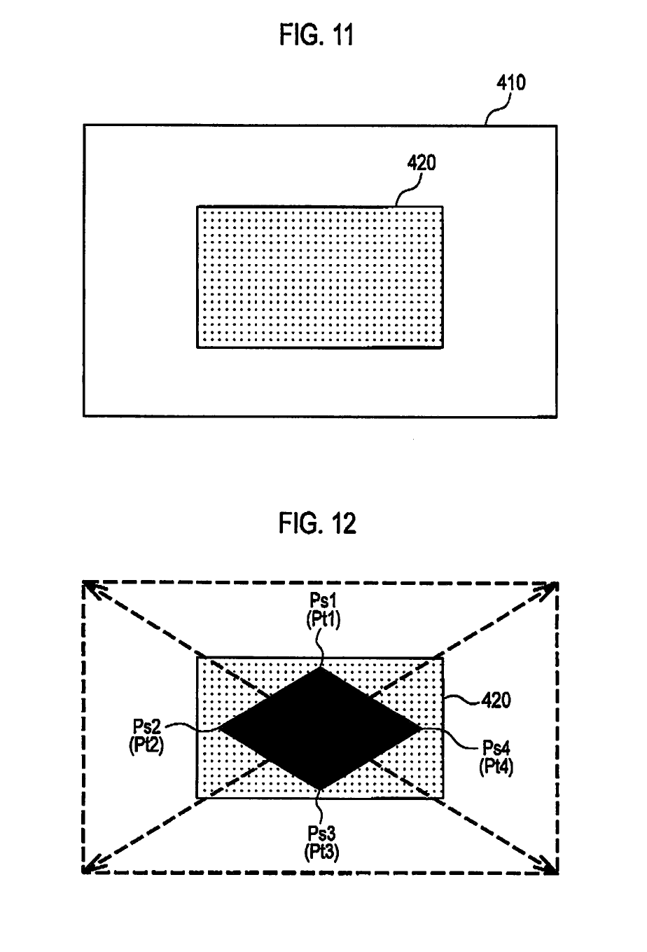

Note that as shown in FIG. 11, the first modification explains a case in which the projectable range 410 is larger than the display frame 420. However, the projectable range 410 need not necessarily be larger than the display frame 420.

(1) As shown in FIG. 12, same as the first embodiment, the projection display apparatus 100 (element control unit 250) controls the liquid crystal panel 50 so as to display the test pattern image. Thus, the projection display apparatus 100 (for example, the aforementioned calculation unit 240) can perform mapping between the coordinates of the projection display apparatus 100 and the coordinates of the imaging element 300 as regards the four intersections included in the test pattern image. In other words, mapping of the intersections Pₛ1 through Pₛ4 and the intersections Pₜ1 through Pₜ4 is performed.

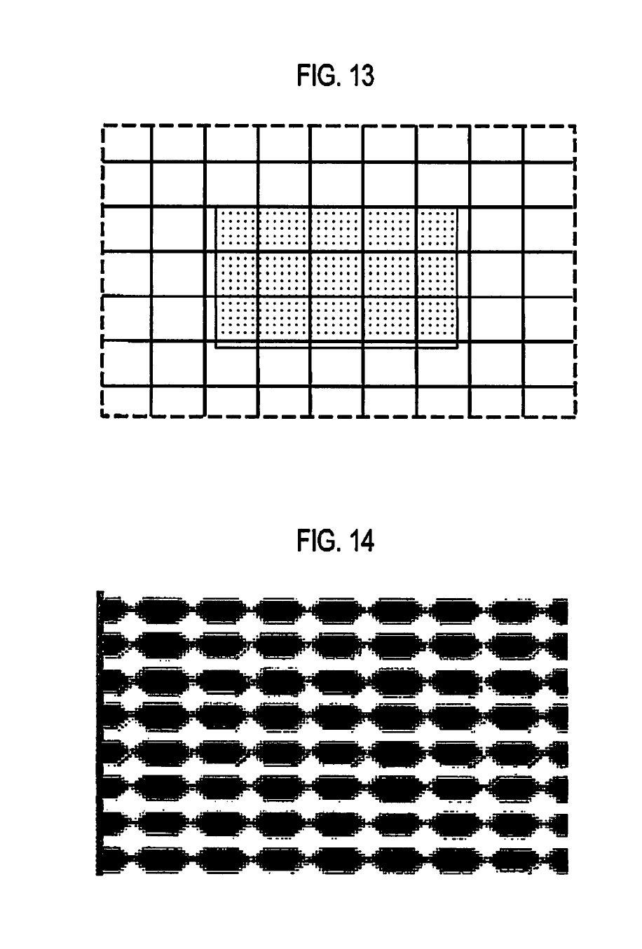

(2) As shown in FIG. 13, the projection display apparatus 100 (for example, the aforementioned calculation unit 240) estimates the mapping of the plurality of coordinates arranged discretely within the projectable range 410 based on the mapping results of the four intersections included in the test pattern image. According to the first modification, the mapping of the plurality of coordinates arranged in a lattice is estimated.

It should be noted that in cases where the projection plane 400 is a curved surface, the estimation accuracy of the mapping at this stage deteriorates.

(3) As shown in FIG. 14, the projection display apparatus 100 (element control unit 250) controls the liquid crystal panel 50 so as to display a coordinate mapping image. Here, the projection display apparatus 100 (for example, the aforementioned calculation unit 240) performs mapping between the coordinates of the projection display apparatus 100 and the coordinates of the imaging element 300 as regards the plurality of characteristic points included in the coordinate mapping image based on the estimation result of the mapping shown in FIG. 13.

In detail, if a case in which mapping is performed for the predetermined characteristic points included in the coordinate mapping image is used as an example, the projection display apparatus 100 specifies the estimated coordinates close to the predetermined characteristic points from among the plurality of estimated coordinates included in the estimated results of mapping. Following this, based on the estimated coordinates that have been specified, the projection display apparatus 100 performs mapping between the coordinates of the projection display apparatus 100 and the coordinates of the imaging element 300 as regards the predetermined characteristic points.

### (Operation and Effect)

According to the first modification, based on the captured image of the test pattern image, the projection display apparatus 100 (element control unit 250) controls the liquid crystal panel 50 so as to display the coordinate mapping image after estimating the mapping of a plurality of coordinates.

Therefore, the accuracy of coordinate mapping can be secured even when the projection plane 400 is a curved surface. Furthermore, even when the coordinate mapping image is monochrome, the accuracy of coordinate mapping can be secured.

### Other Embodiments

The present invention is explained through the above embodiment, but it must not be understood that this invention is limited by the statements and the drawings constituting a part of this disclosure. From this disclosure, a variety of alternate embodiments, examples, and applicable techniques will become apparent to one skilled in the art.

In the aforementioned embodiment, a white light source was illustrated as the light source. However, the light source can also be an LED (Laser Emitting Diode) and an LD (laser Diode).

In the aforementioned embodiment, a transparent liquid crystal panel was illustrated as an imager. However, the imager can also be a reflective liquid crystal panel and a DMD (Digital Micromirror Device).

Although not particularly concerning the aforementioned embodiment, it is desired that the element control unit 250 control the liquid crystal panel 50 such that no image is displayed since the detection of the display frame 420 until the display of the test pattern image.

Although not particularly concerning the aforementioned embodiment, it is desired that the element control unit 250 control the liquid crystal panel 50 such that no image is displayed since the acquisition of the three or more intersections included in the captured test pattern image until the correction of the shape of the image projected on the projection plane 400.

According to the embodiment, in the test pattern image, the background is black and the pattern is white. However, the embodiment is not limited thereto. For example, the background may be white and the pattern may be black. The background may be blue and the pattern may be white. That is, the background and the pattern may be any color as long as there is a difference in intensity between them such that edge detection is possible. Note that the extent in which edge detection is possible is determined in accordance with the accuracy of the imaging element 300. If the difference in intensity between the background and the pattern is high, the accuracy of the imaging element 300 is not considered necessary, which undoubtedly reduces the cost of the imaging element 300.

What is claimed is:

1. A projection display apparatus including an imager that modulates light outputted from a light source, and a projection unit that projects the light outputted from the imager on a projection plane, comprising:
an element control unit that controls the imager so as to display a test pattern image including three or more intersections configured by three or more line segments;
an acquisition unit that acquires a captured image of the test pattern image outputted along a predetermined line from an imaging element that captures the test pattern image projected on the projection plane, specifies the three or more line segments in the captured image of the test pattern image, and acquires the three or more intersections based on the three or more line segments in the captured image;
a calculation unit that calculates a positional relationship between the projection display apparatus and the projection plane based on the three or more intersections in the test pattern image and the three or more intersections in the captured image; and
an adjustment unit that adjusts an image projected on the projection plane in accordance with the positional relationship between the projection display apparatus and the projection plane, wherein
the test pattern image projected on the projection plane is included within a display frame provided on the projection plane.

2. The projection display apparatus according to claim 1, wherein the three or more line segments included in the test pattern image have an inclination with respect to the predetermined line.

3. The projection display apparatus according to claim 1, wherein a maximum size of the test pattern image projected on the projection plane is determined based on a size of the display frame, an angle of view of the projection unit, a maximum inclining angle of the projection plane, and a maximum projection distance from the projection display apparatus to the projection plane.

4. The projection display apparatus according to claim 1, wherein a minimum size of the test pattern image projected on the projection plane is determined based on a resolution of the imaging element and a resolution of the imager.

5. The projection display apparatus according to claim 1, wherein
the element control unit controls the imager so as to display a coordinate mapping image in which a plurality of characteristic points for mapping coordinates of the projection display apparatus and coordinates of the imaging element are arranged discretely, and
the element control unit controls the imager so as to display the coordinate mapping image, after estimating the mapping of a plurality of coordinates based on the captured image of the test pattern image.

6. An image adjustment method of adjusting an image projected on a projection plane by a projection display apparatus, comprising:
a step A of displaying a test pattern image including three or more intersections configured by three or more line segments;
a step B of capturing the test pattern image projected on the projection plane, and acquiring a captured image of the test pattern image outputted along a predetermined line; and
a step C of calculating a positional relationship between the projection display apparatus and the projection plane based on the captured image, and adjusting the image projected on the projection plane in accordance with the positional relationship between the projection display apparatus and the projection plane, wherein
in the step A, the test pattern image is displayed within a display frame provided on the projection plane.

7. The image adjustment method according to claim 6, wherein the three or more line segments included in the test pattern image have an inclination with respect to the predetermined line.
